(19) United States
(12) Patent Application Publication
(10) Pub. No.: US 2013/0320158 A1
(43) Pub. Date: Dec. 5, 2013

(54) PLAIN-TYPE CABLE MANAGING TROUGH

(71) Applicant: Mei-Chi WU, New Taipei City (TW)

(72) Inventor: Mei-Chi WU, New Taipei City (TW)

(21) Appl. No.: 13/483,017

(22) Filed: May 29, 2012

(51) Int. Cl. H02G 3/02

(52) U.S. Cl. 248/69; 248/68.1

(57) ABSTRACT

A plain-type cable managing trough is mainly composed of a cable managing pedestal, and a cable receiving tray over the cable managing pedestal, wherein the cable receiving tray is suitable for receiving at least a cable. The cable managing pedestal is provided with a through hole suitable for having the cable pass therethrough such that the cable can be fixed with the cable managing pedestal. The cable managing pedestal includes a Veltro-fastener ribbon at an end of the cable managing pedestal, wherein the Veltro-fastener ribbon can be wound around the cable such that the cable can be fixed in the cable receiving tray. Thus, space can be saved, the management can be convenient and a neat appearance can be achieved.

### BACKGROUND OF THE DISCLOSURE

a) Field of the Disclosure

The invention relates to a cable managing trough, and more particularly, to a plain-type cable managing trough first fixed with a cable and then wound with a Veltro-fastener ribbon so as to avoid sliding.

b) Brief Description of the Related Art

Currently, most of various electrical or electronic devices are necessary to be connected with a cable for transferring power or signal. With miniaturization of electrical or electronic devices, more and more cables can be expected to be set therein. However, these cables would be inevitably intertwined or tangled with each other or one another and are caused to disorder and not to be easy to organize. Accordingly, space is difficult to be used, electrical or electronic devices are difficult to be managed, and a neat appearance is difficult to be achieved. Further, electronic components in the electrical or electronic devices could cause to have a short circuit. This would result in interruption of operations and affect operation efficiencies of the electrical or electronic devices.

FIG. 1 is a schematically appearance view of a traditional cable managing component. Referring to FIG. 1, in order to solve the above problem of a cable 1 intertwined or tangled with other ones, a current cable managing component 100a is provided with a Veltro-fastener ribbon 2 having a sleeve receiving the cable 1. The cable 1 after folded can be fixed with and wound by the Veltro-fastener ribbon 2. Thereby, the cable 1 can be ordered to be put away. However, the traditional cable managing component has a sleeve receiving the cable 1, and thus easily slides. Even though the Veltro-fastener ribbon 2 of the traditional cable managing component can fix and order the cable 1, a neat appearance is not achieved. Accordingly, the cable managing component is still considered to be improved.

The inventor improves shortcomings of the above cable managing component and thus provides a plain-type cable managing trough capable of fixing and ordering a cable with a neat appearance. In accordance with a motivation of the present invention, a plain-type cable managing trough is developed and assembled for consumers using it.

### SUMMARY OF THE DISCLOSURE

The present invention provides a plain-type cable managing trough improving the shortcomings that the traditional cable managing component easily slides.

In order to achieve the above purpose, the present invention provides a plain-type cable managing trough suitable for managing various disordered cables. The plain-type cable managing trough includes a cable managing pedestal and a cable receiving tray formed over the cable managing pedestal, wherein the cable receiving tray is suitable for receiving at least a cable. The cable managing pedestal is provided with a through hole suitable for having the cable pass therethrough such that the cable can be fixed with the cable managing pedestal. The cable managing pedestal is provided with a Veltro-fastener ribbon at an end of the cable managing pedestal, wherein the Veltro-fastener ribbon can be wound around the cable such that the cable can be fixed in the cable receiving tray.

Thereby, compared with the traditional cable managing component, the cable can be first fixed with the cable managing pedestal so as to avoid sliding, and then the Veltro-fastener ribbon can be wound around the cable such that the cable can be fixed in the cable receiving tray. Accordingly, various disordered cables can be managed and put away. Thus, space can be saved, the management can be convenient and a neat appearance can be achieved. The shortcomings of the traditional cable managing component can be solved.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematically appearance view of a traditional cable managing component.

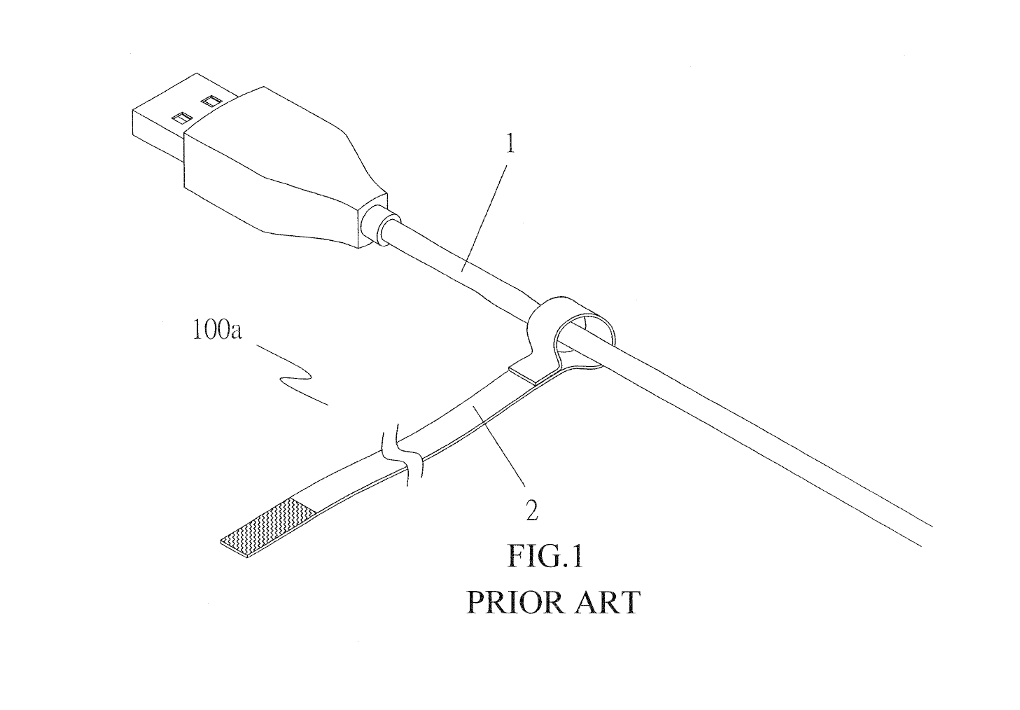

FIG. 2 is a schematically appearance view of a plain-type cable managing trough in accordance with the present invention.

FIG. 3 shows a first operating condition of a plain-type cable managing trough in accordance with the present invention.

FIG. 4 shows a second operating condition of a plain-type cable managing trough in accordance with the present invention.

FIG. 5 shows a third operating condition of a plain-type cable managing trough in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

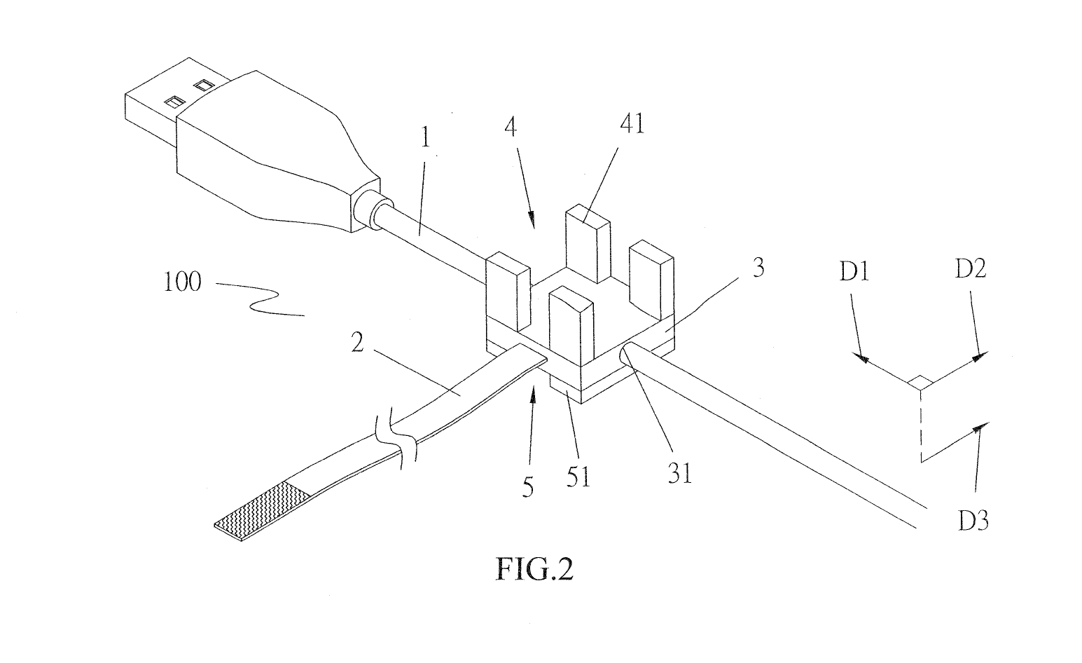

FIG. 2 is a schematically appearance view of a plain-type cable managing trough in accordance with the present invention. Referring to FIG. 2, a plain-type cable managing trough 100 includes a cable managing pedestal 3 and a cable receiving tray 4 formed over the cable managing pedestal 3, wherein the cable receiving tray 4 receives at least a cable 1. The cable managing pedestal 3 is provided with a through hole 31 having the cable 1 pass therethrough such that the cable 1 can be fixed with the cable managing pedestal 3. The cable managing pedestal 3 is provided with a Veltro-fastener ribbon 2 at an end of the cable managing pedestal 3, wherein the Veltro-fastener ribbon 2 can be wound around the cable 1 such that the cable 1 can be fixed in the cable receiving tray 4.

In an embodiment, the cable managing pedestal 3 is shaped like a six sided cuboid. The cable receiving tray 4 is formed over a top surface of the cable managing pedestal 3. The cable receiving tray 4 is composed of four top protruding portions 41 protruding from the top surface, wherein the top protruding portions 41 are separate from one another so as to form a receiving space over the top surface of the cable managing pedestal 3. The cable receiving tray 4 has a first receiving direction D1 and a second receiving direction D2 perpendicular to the first receiving direction D1.

In an embodiment, the cable managing pedestal 3 is provided with a ribbon receiving groove 5 at a bottom surface of the cable managing pedestal 3. Two bottom protruding portions 51 protruding from a bottom surface of the cable managing pedestal 3 form the ribbon receiving groove 5 and are separate from each other so as to from a receiving space at the bottom surface of the cable managing pedestal 3. The ribbon receiving groove 5 has a third receiving direction D3 parallel to the second receiving direction D2. The Veltro-fastener ribbon 2 can be orderly wounded around the cable 1 in the three receiving directions with a neat appearance.

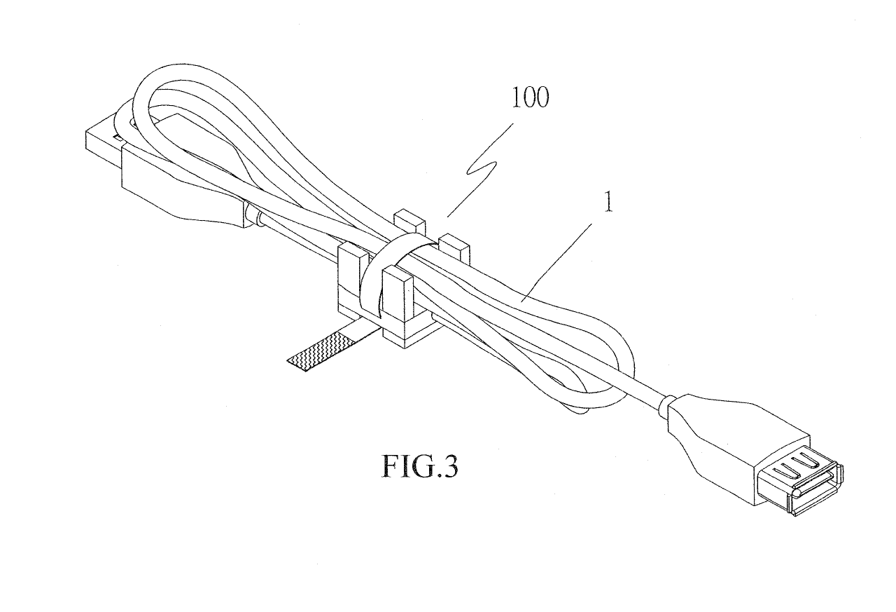

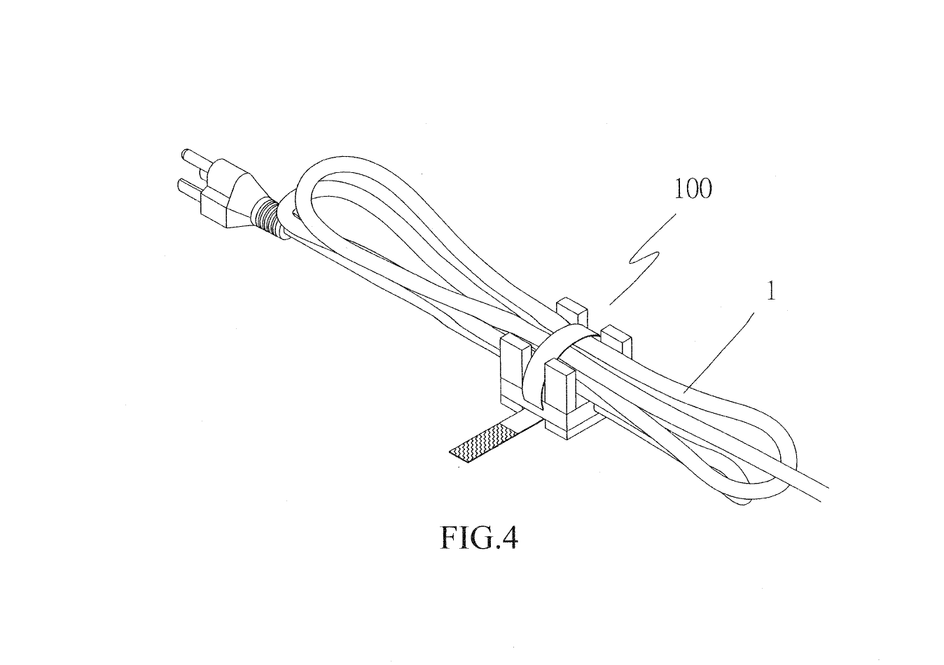

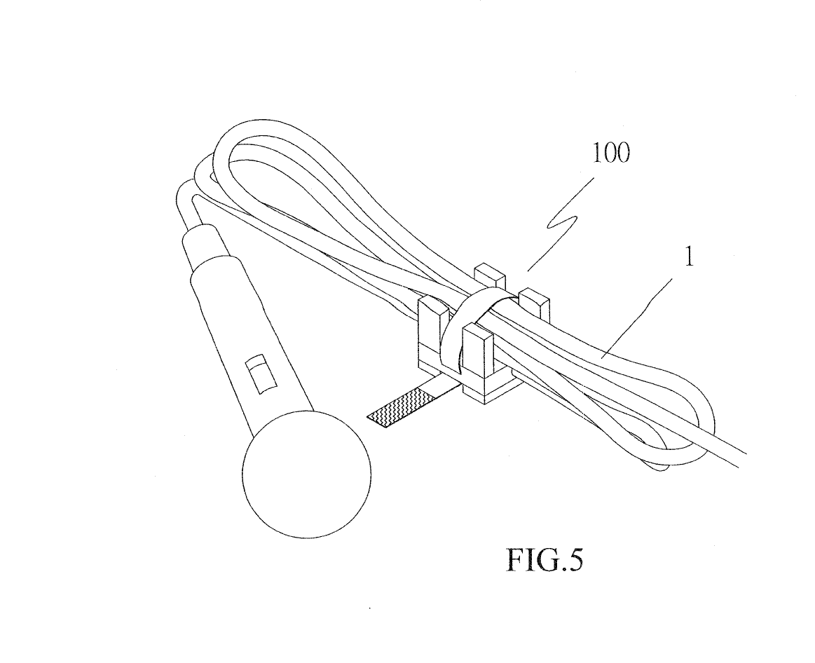

FIGS. 3-5 show first, second and third operating conditions of a plain-type cable managing trough in accordance with the present invention. Referring to FIGS. 3-5, various disordered cables 1 can be managed and put away using the plain-type cable managing trough in accordance with the present invention. Thus, space can be saved, the management can be convenient and a neat appearance can be achieved.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A plain-type cable managing trough suitable for managing various disordered cables, comprising:
a cable managing pedestal; and
a cable receiving tray over the cable managing pedestal, wherein the cable receiving tray is suitable for receiving at least a cable.

2. The plain-type cable managing trough of claim 1, wherein the cable managing pedestal is provided with a through hole suitable for having the cable pass therethrough such that the cable can be fixed with the cable managing pedestal.

3. The plain-type cable managing trough of claim 1, wherein the cable managing pedestal comprises a Veltro-fastener ribbon at an end of the cable managing pedestal, wherein the Veltro-fastener ribbon can be wound around the cable such that the cable can be fixed in the cable receiving tray.

4. The plain-type cable managing trough of claim 1, wherein the cable managing pedestal has a shape of a six sided cuboid, wherein the cable receiving tray is provided over a top surface of the cable managing pedestal.

5. The plain-type cable managing trough of claim 4, wherein the cable receiving tray comprises four top protruding portions protruding from the top surface, wherein the top protruding portions are separate from one another so as to form a receiving space over the top surface of the cable managing pedestal.

6. The plain-type cable managing trough of claim 4, wherein the cable receiving tray has a first receiving direction and a second receiving direction perpendicular to the first receiving direction.

7. The plain-type cable managing trough of claim 1, wherein the cable managing pedestal has a shape of a six sided cuboid, wherein the cable managing pedestal is provided with a ribbon receiving groove at a bottom surface of the cable managing pedestal.

8. The plain-type cable managing trough of claim 7, wherein the cable managing pedestal comprises two bottom protruding portions protruding from a bottom surface of the cable managing pedestal so as to form the ribbon receiving groove, wherein the bottom protruding portions are separate from each other so as to from a receiving space at the bottom surface of the cable managing pedestal.

9. The plain-type cable managing trough of claim 7, wherein the ribbon receiving groove has a third receiving direction.

10. The plain-type cable managing trough of claim 6, wherein the cable managing pedestal is provided with a ribbon receiving groove at a bottom surface of the cable managing pedestal, wherein the ribbon receiving groove has a third receiving direction parallel to the second receiving direction.

11. The plain-type cable managing trough of claim 9, wherein the cable receiving tray has a first receiving direction and a second receiving direction perpendicular to the first receiving direction, wherein the third receiving direction is parallel to the second receiving direction.
